(19) United States
(12) Patent Application Publication
(10) Pub. No.: US 2021/0178614 A1
(43) Pub. Date: Jun. 17, 2021

(54) SHOCK ABSORBING DEVICE AND ROBOT HAVING THE SAME

(71) Applicant: Kawasaki Jukogyo Kabushiki Kaisha, Kobe-shi (JP)

(72) Inventor: Junichi MURAKAMI, Kobe-shi (JP)

(73) Assignee: Kawasaki Jukogyo Kabushiki Kaisha, Kobe-shi (JP)

(21) Appl. No.: 17/185,118

(22) Filed: Feb. 25, 2021

Related U.S. Application Data
(63) Continuation of application No. PCT/JP2019/033442, filed on Aug. 27, 2019.

(30) Foreign Application Priority Data
Aug. 30, 2018 (JP) 2018-161628

(51) Int. Cl. B25J 19/00; B25J 13/08

(52) U.S. Cl. CPC B25J 19/0091; B25J 13/085

(57) ABSTRACT

A shock absorbing device is configured to reduce shock transmitted from a first object to a second object. The shock absorbing device includes an outer shell comprising of an elastic body, the outer shell configured to contain the first object; a sensor configured to detect one of a first external force applied by the second object to the outer shell, a second external force applied by the second object to the first object via the outer shell, and a physical quantity corresponding to one of the first and second external forces; and a motion suppressing device configured to suppress motion of the first object and the outer shell based on a value detected by the sensor.

### CROSS-REFERENCE TO RELATED APPLICATIONS

The present application claims priority to PCT/JP2019/033442 filed Aug. 27, 2019, and JP 2018-161628 filed Aug. 30, 2018, both of which are incorporated herein by reference.

### TECHNICAL FIELD

The present disclosure relates to a shock absorbing device and a robot having the shock absorbing device.

### BACKGROUND

Conventionally, shock absorbing devices reduce shock transmitted from a first object to a second object. As one example of such shock absorbing devices is a covering material which covers a manipulator. The covering material has a cushion layer, a contact sensor disposed on the outer side of the cushion layer, a proximity sensor disposed on the outer side of the contact sensor, and a coating layer disposed outermost.

Meanwhile, the covering material and other conventional shock absorbing devices generally include an outer shell containing the first object, such as an internal structure of the manipulator, a sensor which detects an external force applied by the second object to the outer shell or an external force applied by the second object to the first object via the outer shell, and a motion suppressing device which suppresses motion of the first object and the outer shell based on a value detected by the sensor.

However, such conventional shock absorbing devices have transmit some shock from the first object to the second object. Moreover, the external force applied by the second object to the outer shell, or the external force applied by the second object to the first object via the outer shell, may not be accurately detected by the sensor. Therefore, the motion suppressing device may not be able to suppress the motion of the first object and the outer shell as desired based on the value detected by the sensor.

### SUMMARY

In order to solve the above-described problems, a shock absorbing device according to the present disclosure is configured to reduce shock transmitted from a first object to a second object. The shock absorbing device comprises an outer shell comprising of an elastic body, the outer shell configured to contain the first object; a sensor configured to detect one of a first external force applied by the second object to the outer shell, a second external force applied by the second object to the first object via the outer shell, and a physical quantity corresponding to one of the first and second external forces; and a motion suppressing device configured to suppress motion of the first object and the outer shell based on a value detected by the sensor.

### BRIEF DESCRIPTION OF THE DRAWINGS

FIG. 1 is a plan view illustrating a worksite where a shock absorbing device and a robot having the shock absorbing device work cooperatively with a human body (human).

FIG. 2 is a schematic view illustrating a configuration of the shock absorbing device and the robot.

FIG. 3 is a block diagram illustrating components of the shock absorbing device and the robot.

FIG. 4(A) is a perspective view illustrating a state where a first outer shell of the shock absorbing device as viewed from the outside.

FIG. 4(B) is a perspective view illustrating a state where a first outer shell of the shock absorbing device as viewed from the inside.

FIG. 5(A) is a schematic view of a snap-fit structure before fixing a pair of outer shell bodies of the shock absorbing device.

FIG. 5(B) is a schematic view of a snap-fit structure after fixing a pair of outer shell bodies of the shock absorbing device.

FIG. 6(A) is a front perspective view illustrating a state where the first outer shell of the shock absorbing device is attached to a wrist.

FIG. 6(B) is a back perspective view illustrating a state where the first outer shell of the shock absorbing device is attached to a wrist.

FIG. 7(A) is a view illustrating a positional relationship between the first outer shell of the shock absorbing device and a base-end part of a wrist structure of the robot.

FIG. 7(B) is a view illustrating a positional relationship between the first outer shell of the shock absorbing device and a middle part of the wrist.

FIG. 7(C) is a view illustrating a positional relationship between the first outer shell of the shock absorbing device and a tip-end part of the wrist.

FIG. 8 is a view illustrating a modification of a first outer shell back part of the first outer shell of the shock absorbing device.

FIG. 9(A) is a perspective view illustrating a state before a second outer shell of the shock absorbing device is attached to a first link of the robot and a decorative label.

FIG. 9(B) is a cross-sectional view illustrating a fixing part of the second outer shell of FIG. 9(A) and its peripheral part.

FIG. 10(A) is a perspective view illustrating a state where the second outer shell of the shock absorbing device is attached to the first link of the robot.

FIG. 10(B) is a cross-sectional view of the fixing part of FIG. 10(A) and its peripheral part.

FIG. 11 is a perspective view illustrating a state where a third outer shell of the shock absorbing device as seen from inside.

FIG. 12(A) is a perspective view illustrating a state where the third outer shell of the shock absorbing device is attached to a second link of the robot as seen from a first surface side.

FIG. 12(B) is a perspective view illustrating the state where the third outer shell of the shock absorbing device is attached to the second link of the robot as seen from a second surface side.

FIG. 12(C) is a cross-sectional view illustrating the fixing part and its peripheral part.

FIG. 13(A) is a schematic cross-sectional view illustrating an effect of the shock absorbing device before an external force is applied by a human body to the outer shell.

FIG. 13(B) is a schematic cross-sectional view illustrating an effect of the shock absorbing device when the external force is applied by the human body.

FIG. 14 is a schematic view illustrating an experiment conducted by the present inventors in order to confirm the effect of the shock absorbing device.

FIG. 15 is a graph illustrating a result of the experiment conducted by the present inventors illustrated in FIG. 14.

FIG. 16(A) is a view illustrating a positional relationship between a first outer shell of a conventional shock absorbing device and a base-end part of a wrist of an internal structure of a robot.

FIG. 16(B) is a view illustrating the positional relationship between the first outer shell of the conventional shock absorbing device and a middle part of the wrist.

FIG. 16(C) is a view illustrating the positional relationship between the first outer shell of the conventional shock absorbing device and a tip-end part of the wrist.

FIG. 17(A) is a schematic cross-sectional view illustrating the conventional shock absorbing device before an external force is applied by the human body to an outer shell.

FIG. 17(B) is a schematic cross-sectional view illustrating the conventional shock absorbing device when the external force is applied by the human body.

### DETAILED DESCRIPTION OF THE DRAWINGS

Hereinafter, a shock absorbing device and a robot having the shock absorbing device are described with reference to the accompanying drawings. Note that the present disclosure is not limited to these devices. Moreover, below, the same reference characters are given to the same or corresponding components throughout the drawings to omit redundant description.

(Robot 10)

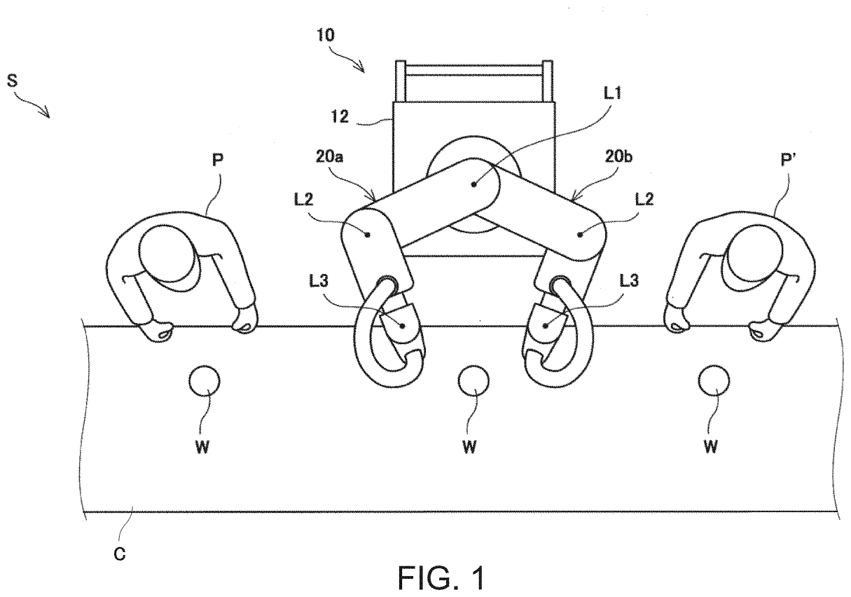

FIG. 1 is a plan view illustrating a worksite where the shock absorbing device and the robot having the shock absorbing device according to an embodiment work cooperatively with a human body (human). As illustrated in FIG. 1, a robot 10 is an industrial robot which works cooperatively with human bodies P and P′ (a second object) at a worksite S. In detail, the robot 10 is installed between the human body P and the human body P′ within a limited space corresponding to a space for one person (e.g., 610 mm×620 mm). Then, the robot 10 can work cooperatively with the human bodies P and P′ on a plurality of workpieces W which are sequentially conveyed by a conveyor C.

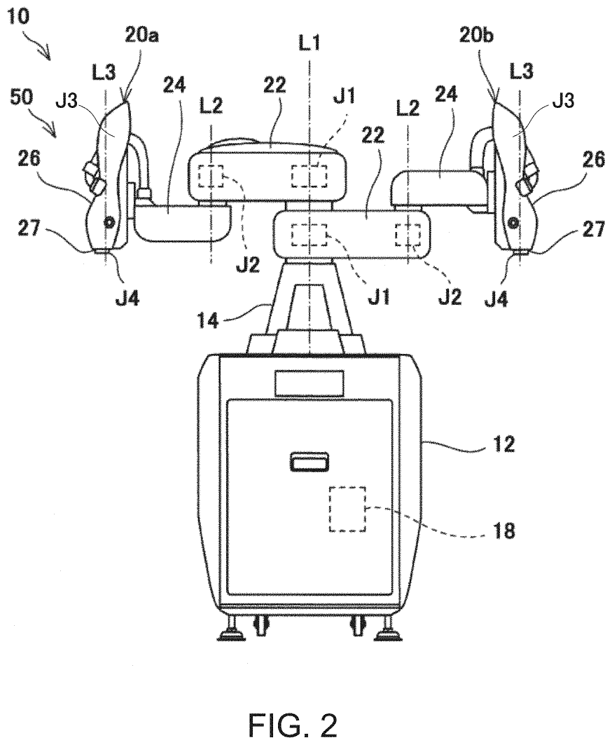

FIG. 2 is a schematic view illustrating the entire configuration of the shock absorbing device and the robot having the shock absorbing device. As illustrated in FIG. 2, the robot 10 includes a pedestal 12 fixed to a carriage, a robot controlling device 18 accommodated in the pedestal 12 and illustrated by a broken line in FIG. 1, and a pair of robotic arms 20a and 20b supported by the pedestal 12. Note that although an end effector which, for example, grips the workpiece W may be attached to a tip end of each of the robotic arms 20a and 20b, illustration and description thereof are omitted here.

(Pair of Robotic Arms 20a and 20b)

The pair of robotic arms 20a and 20b are horizontally articulated robotic arms which are movable with respect to the pedestal 12. The pair of robotic arms 20a and 20b can operate independently from and in connection with each other. Note that since the robotic arm 20b has a similar configuration to the robotic arm 20a, only the robotic arm 20a is described here and similar description of the robotic arm 20b is suitably omitted.

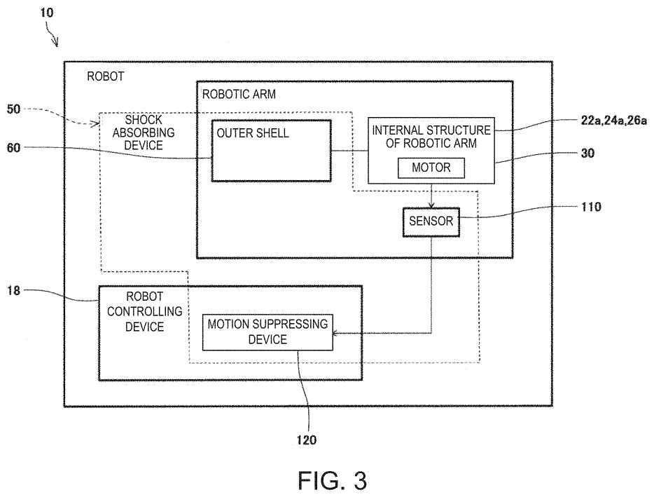

The robotic arm 20a has joint parts J1-J4 (joint axes). Then, the robotic arm 20a is provided with driving motors 30 corresponding to the joint parts J1-J4 (see FIG. 3). The robotic arm 20a has a first link 22, a second link 24, and a wrist 26.

The first link 22 is coupled to a base shaft 14 fixed to an upper surface of the pedestal 12 by the rotary joint part J1, and thus, rotatable about a rotational axis L1 defined passing through the axial center of the base shaft 14. The second link 24 is coupled to a tip end of the first link 22 by the rotary joint part J2, and thus, rotatable about a rotational axis L2 defined at the tip end of the first link 22.

The wrist 26 has a mechanical interface 27 to which the end effector is attached, and is coupled to a tip end of the second link 24 via the linear-motion joint part J3 and the rotary joint part J4. The wrist 26 is ascendable and descendible with respect to the second link 24 by the linear-motion joint J3. Moreover, the wrist 26 is rotatable about a vertical rotational axis L3 with respect to the second link 24 by the rotary joint part J4.

The rotational axis L1 of the first link 22 of the robotic arm 20a and the rotational axis L1 of the first link 22 of the robotic arm 20b exist on the same straight line, and the first link 22 of the robotic arm 20a and the first link 22 of the robotic arm 20b are disposed with a height difference therebetween.

Although a concrete configuration of the robot controlling device 18 is not particularly limited, it may be implemented by a known processor (e.g., a CPU) operating in accordance with a program stored in a memory.

(Shock Absorbing Device 50)

FIG. 3 is a block diagram illustrating the entire configuration of the shock absorbing device and the robot having the shock absorbing device. As illustrated in FIG. 3, the robot 10 is further provided with a shock absorbing device 50 which reduces the shock transmitted from an internal structure (a first object) of the robot 10 to the human body P and the human body P′. The internal structure of the robot 10 includes a structure provided inside the robot 10 (e.g., the motors 30 provided inside the robotic arms 20a and 20b, an internal structure 22a of the first link, an internal structure 24a of the second link, and an internal structure 26a of the wrist (described later)).

The shock absorbing device 50 is provided with an outer shell 60 that contains and houses the internal structure (the first object) of the robot 10 and comprised of an elastic body with flexibility. The shock absorbing device 50 is further provided with a sensor 110 which detects an external force applied by the human bodies P and P′ (the second object) to the internal structure of the robot 10 via the outer shell 60. Then, the shock absorbing device 50 is further provided with a motion suppressing device 120 which suppresses the motion of the robot 10 (e.g., the internal structure and the outer shell 60 of the robot 10) based on the value detected by the sensor 110.

(Outer Shell 60)

The outer shell 60 constitutes an outer shell of the robot 10. In detail, the outer shell 60 includes a first outer shell 70 constituting an outer shell of the wrist 26 of the robotic arm 20a, a second outer shell 80 constituting an outer shell of the first link 22 of the robotic arm 20a, and a third outer shell 90 constituting an outer shell of the second link 24 of the robotic arm 20a. That is, the outer shell 60 is configured as an outer shell of the internal structure of the robotic arm 20a (and the robotic arm 20b).

The outer shell 60 (i.e., each of the first outer shell 70, the second outer shell 80, and the third outer shell 90) has a wall that is thin, and a gap is formed between the outer shell 60 and the internal structure of the robot 10. The thickness of the wall may be 5.0 mm or below. Alternatively, the thickness of the wall may be 1.0 mm or above and 2.0 mm or below.

Moreover, the elastic body which constitutes the outer shell 60 also has incompressibility. Note that the incompressibility as used herein refers to a property of the outer shell 60 that when it is applied with the external force by the human bodies P and P′ (the second object), its density (or a volume) does not change (or hardly changes) before and after an elastic deformation.

Moreover, the elastic body which constitutes the outer shell 60 is made of non-foamed resin. A primary component of the non-foamed resin is polyethylene.

The polyethylene may be LDPE (Low Density Polyethylene). Alternatively, the polyethylene may be HDPE (High Density Polyethylene), LLDPE (Linear Low Density Polyethylene), MPE (Metallocene Polyethylene, or polyethylene polymerized using metallocene catalyst), EVA (Ethylene-Vinyl Acetate), UHM WPE (Ultra High Molecular Weight Polyethylene), or any combination of these polyethylene, for example.

Moreover, an inner surface of the outer shell 60 opposing to the internal structure of the robot 10 is smooth.

Although the outer shell 60 further includes the first outer shell 70, the second outer shell 80, and the third outer shell 90 which constitute an outer shell of the robotic arm 20b, their configurations are the same as those of the outer shell of the robotic arm 20a. Therefore, below, only the outer shell of the first robotic arm 20a is described unless particularly needed, and similar description for the second robotic arm 20b is suitably omitted.

(First Outer Shell 70)

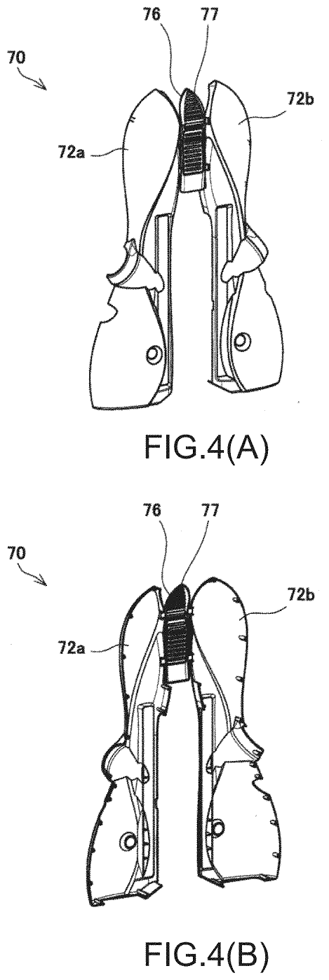

FIGS. 4(A) and 4(B) are perspective views illustrating a state where the first outer shell of the shock absorbing device opens, where FIG. 4(A) is a view when seen from outside, and FIG. 4(B) is a view when seen from inside. As illustrated in FIGS. 4(A) and 4(B), the first outer shell 70 has a pair of first outer shell bodies 72a and 72b, and a first outer shell back part 76 coupling the back side of a base-end part of the first outer shell body 72a and the back side of a base-end part of the first outer shell body 72b.

Each of the pair of first outer shell bodies 72a and 72b has two substantially bowl shapes connected vertically to each other, so that the pair of first outer shell bodies 72a and 72b can cooperatively contain the wrist internal structure 26a therein.

The first outer shell 70 can be attached to the wrist internal structure 26a in the following procedure, for example.

First, as illustrated in FIG. 4(A), the first outer shell 70 is opened so that the first outer shell bodies 72a and 72b are opened to be spread centering on the first outer shell back part 76.

Next, an inner surface of the first outer shell back part 76 is slid from upward to be attached to the wrist internal structure 26a.

Then, the first outer shell body 72a is inwardly bent at the connected part with the first outer shell back part 76, and the first outer shell body 72b is inwardly bent at the connected part with the first outer shell back part 76, so that an inner surface of the first outer shell body 72a and an inner surface of the first outer shell body 72b face to each other having the wrist internal structure 26a therebetween.

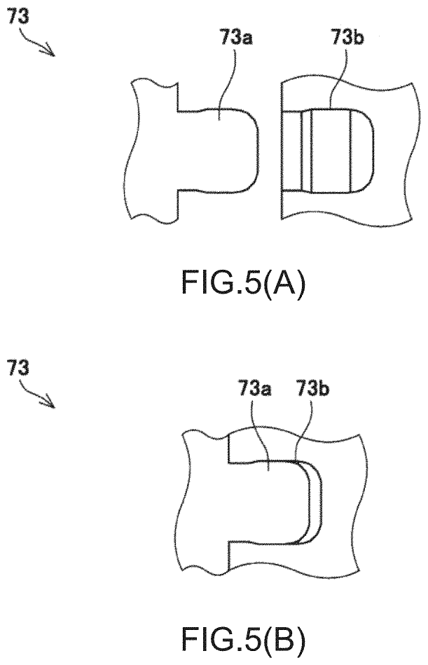

Finally, the first outer shell bodies 72a and 72b are fixed to each other by a snap-fit structure 73 (see FIGS. 5(A) and 5(B)) provided at end edges of the substantially bowl shapes of the first outer shell bodies 72a and 72b extending in the height direction on the opposite side of the second link 24.

FIGS. 5(A) and 5(B) are schematic views of the snap-fit structure which fixes the pair of first outer shell bodies of the shock absorbing device, where FIG. 5(A) is a view before the fixing, and FIG. 5(B) is a view after the fixing. As illustrated in FIGS. 5(A) and 5(B), the snap-fit structure 73 has a known structure in which a male part 73a provided to one of the first outer shell bodies 72a and 72b, and a female part 73b provided to the other one of them are engaged with each other using an elastic deformation of the male part 73a.

Note that a plurality of snap-fit structures 73 may be provided having a gap therebetween in the height direction, to the end edges of the substantially bowl shapes of the first outer shell bodies 72a and 72b extending in the height direction on the opposite side of the second link 24. Therefore, the first outer shell bodies 72a and 72b can be strongly fixed to each other. Moreover, the snap-fit structure 73 may be provided to the inner surfaces of the first outer shell bodies 72a and 72b. Accordingly, since the snap-fit structure 73 becomes invisible from outside when the first outer shell 70 is attached to the wrist internal structure 26a, an appearance can be improved and the snap-fit structure 73 can be prevented from being caught by other objects.

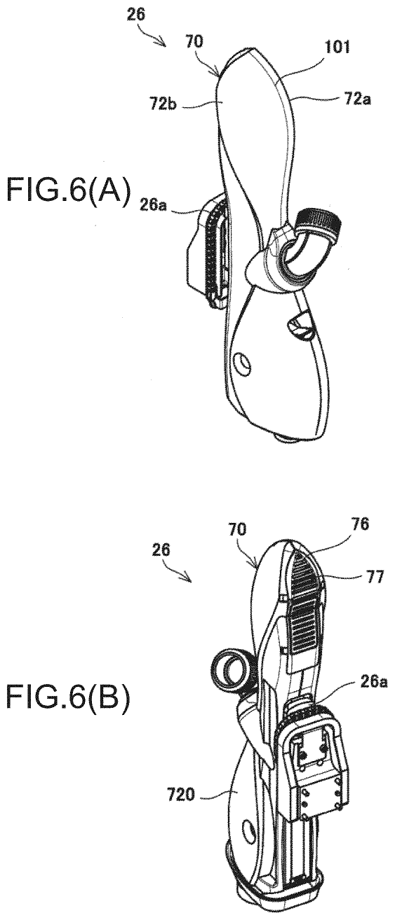

FIGS. 6(A) and 6(B) are views illustrating a state where the first outer shell of the shock absorbing device is attached to the wrist, where FIG. 6(A) is a front perspective view, and FIG. 6(B) is a back perspective view. As illustrated in FIGS. 6(A) and 6(B), the first outer shell 70 has a curved part 101 protruding outwardly in a thickness direction (i.e., the opposite side from the wrist internal structure 26a). The curved part 101 is formed from the base-end part to the tip-end part of the first outer shell 70 by the end edges of the substantially bowl shapes of the first outer shell bodies 72a and 72b, which extend in the height direction on the opposite side of the second link 24, being fixed to each other by the snap-fit structure 73.

Note that a part of the wrist internal structure 26a may be exposed from the first outer shell 70. As illustrated in FIG. 6(B), a vent 77 is provided on the first outer shell back part 76 so as to discharge heat generated by the wrist internal structure 26a to outside.

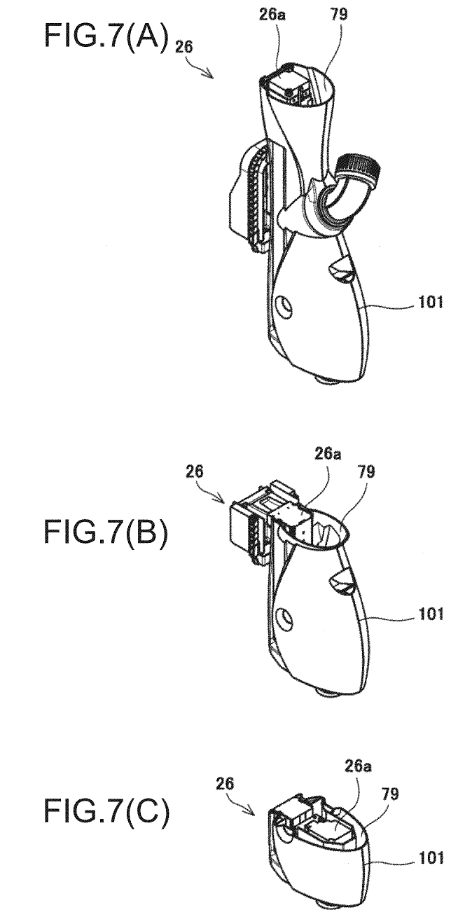

FIGS. 7(A) to 7(C) are views illustrating a positional relationship between the first outer shell of the shock absorbing device and the internal structure of the robot, where FIG. 7(A) illustrates a base-end part of the wrist, FIG. 7(B) illustrates a middle part of the wrist, and FIG. 7(C) illustrates a tip-end part of the wrist. As illustrated in FIGS. 7(A) to 7(C), since the first outer shell 70 is formed to be thin, a gap is formed between the wrist internal structure 26a and the first outer shell 70. Therefore, an internal space 79 is formed from the base-end part to the tip-end part of the wrist 26.

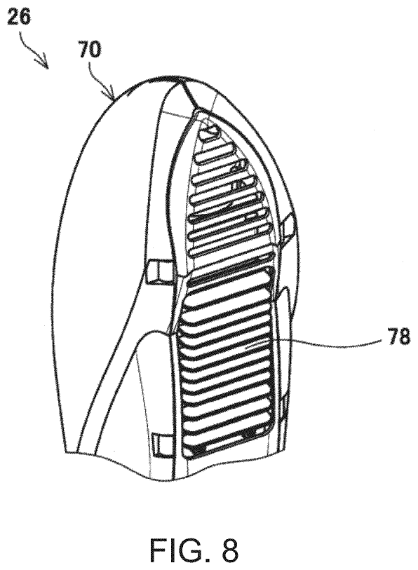

FIG. 8 is a view illustrating a modification of the first outer shell back part of the shock absorbing device. As illustrated in FIG. 8, a part of the vent 77 may be notched so that a heat sink 78 is provided therein. Accordingly, the heat generated by the wrist internal structure 26a can further be discharged outside.

(Second Outer Shell 80)

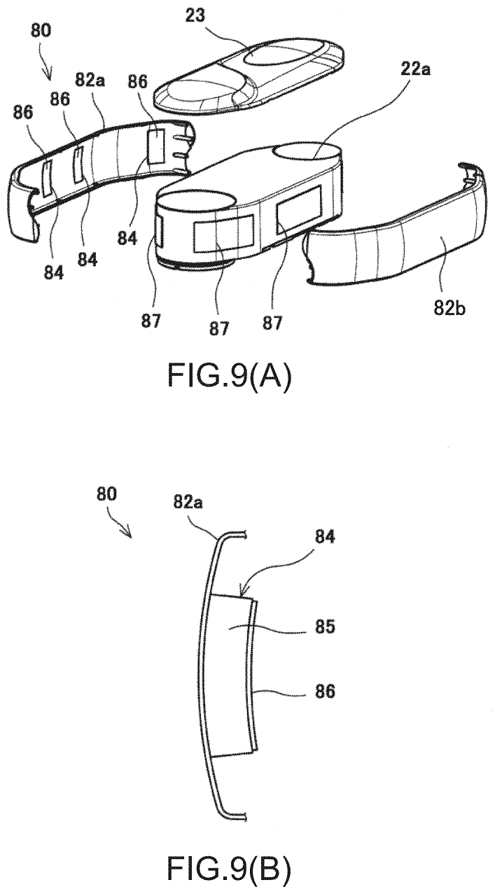

FIGS. 9(A) and 9(B) are views illustrating a state before the second outer shell of the shock absorbing device is attached to the first link of the robot, where FIG. 9(A) is a perspective view of the second outer shell, and the first link and a decorative panel, and FIG. 9(B) is a cross-sectional view illustrating a fixing part and its peripheral part of the second outer shell.

As illustrated in FIG. 9(A), the second outer shell 80 has a pair of second outer shell bodies 82a and 82b. The shapes of the pair of second outer shell bodies 82a and 82b are the same. The pair of second outer shell bodies 82a and 82b are attached to the first link internal structure 22a so as to cooperatively cover the entire area of the side surface, and edge parts of an upper surface and a bottom surface of the first link internal structure 22a.

The pair of second outer shell bodies 82a and 82b are provided on their inner surfaces with a plurality of fixing parts 84, which fix to the side surface of the first link internal structure 22a. As illustrated in FIG. 9(B), each fixing part 84 has a sponge foam 85 of which one principal surface is fixed to the inner surface of the second outer shell body 82a or 82b, and a hook-and-loop fastener 86 provided on the other principal surface of the sponge foam 85.

The sponge foam 85 is made of, for example, a material with flexibility, which easily deforms when an external force is applied, and easily recovers the previous shape when the external force stops to be applied (e.g., a sponge as generally used in a kitchen). That is, the sponge foam 85 can elastically deform easily.

Note that the hook-and-loop fastener 86 may be attached to the principal surface of the sponge foam 85 by an adhesive etc. Although a decorative panel 23 is attached to an upper surface of the first link 22 of the first robotic arm 20a, the decorative panel 23 is not attached to that of the second robotic arm 20b.

The second outer shell 80 can be attached to the first link internal structure 22a by, for example, the second outer shell body 82a and the second outer shell body 82b being horizontally flipped with respect to each other and contacted to the side surface of the first link internal structure 22a, so that the hook-and-loop fasteners 86 are fixed to hook-and-loop fasteners 87 provided at the corresponding positions in the first link internal structure 22a. Note that the hook-and-loop fasteners 86 of the second outer shell bodies 82a and 82b have one of a hook structure and a loop structure, and the hook-and-loop fasteners 87 of the first link internal structure 22a have the other one of the hook structure and the loop structure.

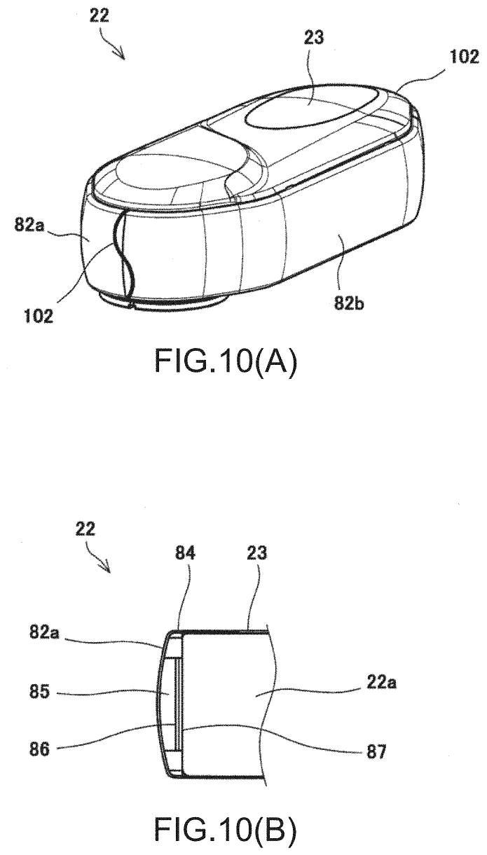

FIGS. 10(A) and 10(B) are views illustrating a state where the second outer shell of the shock absorbing device is attached to the first link of the robot, where FIG. 10(A) is a perspective view, and FIG. 10(B) is a cross-sectional view of the fixing part and its peripheral part.

The second outer shell body 82a and the second outer shell body 82b are fixed to each other by fitting structures provided to their end surfaces. Note that the fitting structure may be a snap-fit structure similarly to the first outer shell 70, or may be a known fitting structure provided with a pin and a corresponding pin receiver.

As illustrated in FIG. 10(B), the pair of second outer shell bodies 82a and 82b are fixed to the side surface of the first link internal structure 22a by the plurality of fixing parts 84. In detail, the pair of second outer shell bodies 82a and 82b are pressed toward the first link internal structure 22a, and thus, the hook-and-loop fasteners 86 of the fixing parts 84 are fixed to the hook-and-loop fasteners 87 provided to the side surface of the first link internal structure 22a. Then, by the pressing being canceled, the sponge foams 85 elastically deform and maintain a state extending toward the side surface of the first link internal structure 22a, and thus, the pair of second outer shell bodies 82a and 82b are fixed to the side surface of the first link internal structure 22a.

Note that as illustrated in FIG. 10(A) the second outer shell 80 has curved parts 102 protruding outwardly in its thickness direction (i.e., the opposite side from the first link internal structure 22a), similarly to the first outer shell 70. End edges on both sides of the second outer shell bodies 82a and 82b extending in the height direction are fixed to each other so as to form the curved parts 102 entirely in the height direction on a base-end side and a tip-end side of the second outer shell 80

(Third Outer Shell 90)

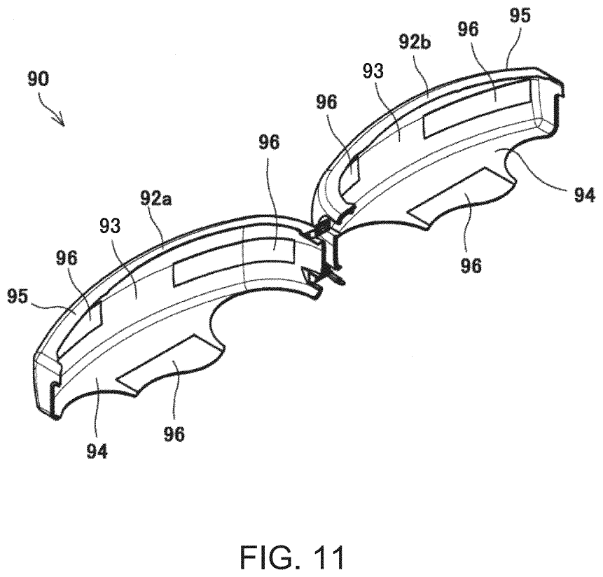

FIG. 11 is a perspective view illustrating a state where the third outer shell of the shock absorbing device opens, when seen from inside. As illustrated in FIG. 11, the third outer shell 90 has a pair of third outer shell bodies 92a and 92b. Each of the pair of third outer shell bodies 92a and 92b has a third outer shell side part 93 which covers a side surface of the second link 24, a third outer shell one surface part 94 which covers a part of a first surface of the second link 24, a third outer shell other surface part 95 which covers a part of a second surface of the second link 24.

In FIG. 11, the third outer shell side part 93 of each of the pair of third outer shell bodies 92a and 92b is curved so as to protrude outwardly when seen from above, and vertically extending edge parts of the respective third outer shell side parts 93 are coupled to each other so as to be inwardly bendable. The third outer shell side part 93 of each of the pair of third outer shell bodies 92a and 92b is provided on its inner surface with a plurality of fixing parts 96 configured similarly to the fixing parts 84 provided to the inner surface of the pair of second outer shell bodies 82a and 82b. That is, each fixing part 96 has a sponge foam 97 of which one principal surface is fixed to an inner surface of the third outer shell body 92a or 92b, and a hook-and-loop fastener 98 provided on the other principal surface of the sponge foam 97.

In FIG. 11, the third outer shell one surface part 94 inwardly and horizontally extends from a lower-end edge of the third outer shell side part 93. Note that the fixing part 96 similar to the one provided to the third outer shell side part 93 is provided to an inner surface of the third outer shell one surface part 94. Moreover, the third outer shell other surface part 95 inwardly and horizontally extends from an upper-end edge of the third outer shell side part 93.

The third outer shell 90 can be attached to the second link internal structure 24a by, for example, the third outer shell body 92a and the third outer shell body 92b being inwardly bent at the connected part, and contacted on the side surface of the second link internal structure 24a, so that the hook-and-loop fasteners 98 are fixed to hook-and-loop fasteners 99 provided at the corresponding positions in the second link internal structure 24a. Note that the hook-and-loop fasteners 98 of the third outer shell bodies 92a and 92b have one of the hook structure and the loop structure of the known hook-and-loop fastener, and the hook-and-loop fasteners 99 of the second link internal structure 24a have the other one of the hook structure and the loop structure.

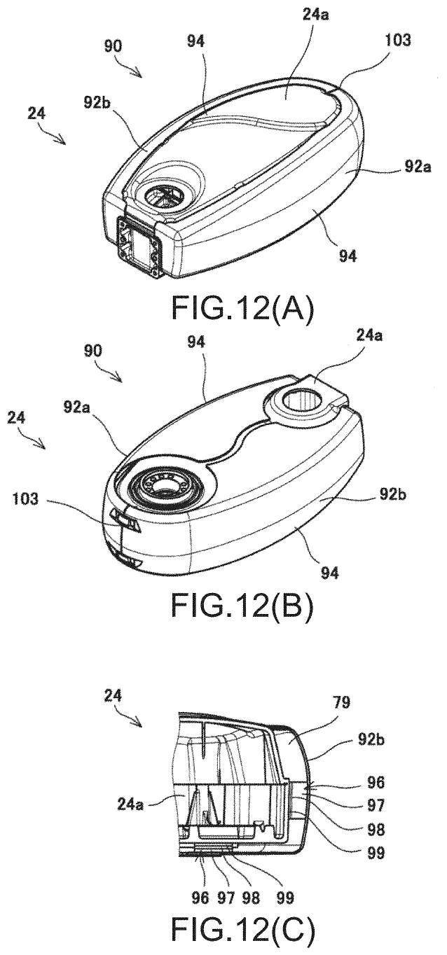

FIGS. 12(A) to 12(C) are views illustrating a state where the third outer shell of the shock absorbing device is attached to the second link of the robot, where FIG. 12(A) is a perspective view when seen from the first surface side, FIG. 12(B) is a perspective view when seen from the second surface side, and FIG. 12(C) is a cross-sectional view illustrating the fixing part and its peripheral part.

The third outer shell body 92a and the third outer shell body 92b are fixed to each other by a fitting structure provided to their end surfaces opposite from the end surfaces bendably connected to each other. Note that the fitting structure may be a snap-fit structure similarly to the first outer shell 70, or may be a known fitting structure provided with a pin and a corresponding pin receiver.

As illustrated in FIG. 12(C), the pair of the third outer shell bodies 92a and 92b are fixed to the second link internal structure 24a by the plurality of fixing parts 96. Note that since a mode of the fixing is similar to the fixing of the first link internal structure 22a to the second outer shell 80 as described above, description is not repeated.

Note that, as illustrated in FIGS. 12(A) and 12(B), the third outer shell 90 has a curved part 103 protruding outwardly in the thickness direction (i.e., the opposite side from the second link internal structure 24a), similarly to the first outer shell 70 and the second outer shell 80. The end edges of the third outer shell bodies 92a and 92b extending in the height direction on the opposite side of the bendably connected part are fixed to each other so as to form the curved part 103 entirely in the height direction of the end edges.

(Sensor 110)

Returning to FIG. 3, the sensor 110 detects an amount of change in a rotational speed of the motors 30, as an external force applied by the human bodies P and P′ to the internal structure of the robot 10 via the outer shell 60 (a first part) of the robotic arms 20a and 20b.

(Motion Suppressing Device 120)

As illustrated in FIG. 3, the motion suppressing device 120 may be configured as a part of the robot controlling device 18. Although a concrete configuration of the motion suppressing device 120 is not particularly limited, it may be implemented by a known processor (e.g., a CPU) operating in accordance with a program stored in a memory.

Note that the motion suppressing device 120 may suppress the operation (motion) of the robot 10 by suspending the operation of the robot 10, for example. Alternatively, the operation of the robot 10 may be suppressed by reducing the speed or acceleration of the robot 10, or may be suppressed by other modes.

(Effects)

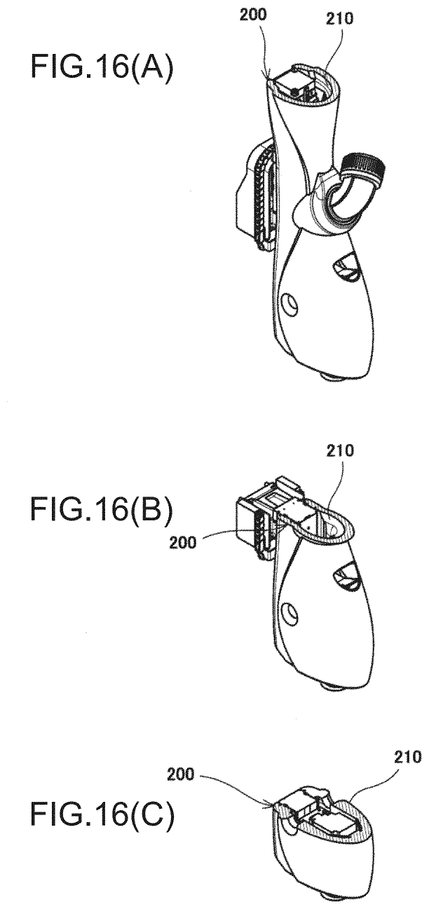

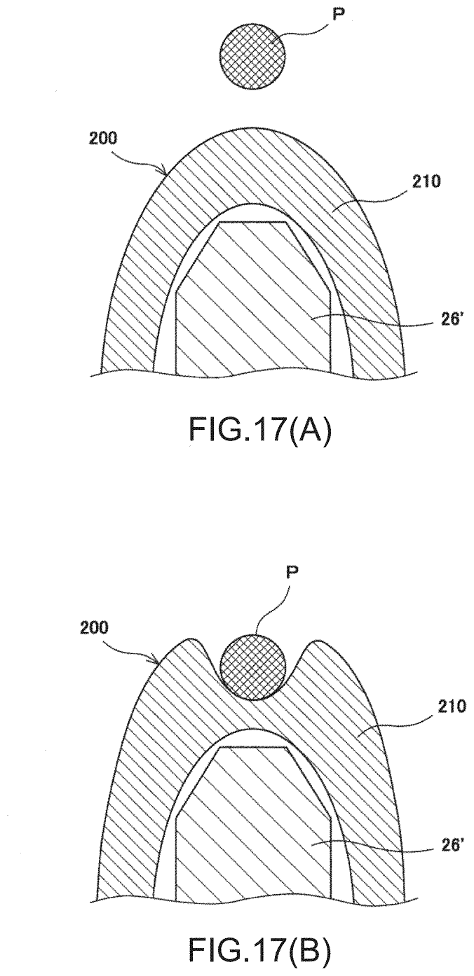

Here, in order to describe the effects achieved by the shock absorbing device 50, a conventional shock absorbing device 200 is described with reference to FIGS. 16(A), 16(B), 16(C), and FIGS. 17(A) and 17(B). FIGS. 16 (A) to 16(C) are views illustrating a positional relationship between a first outer shell of the conventional shock absorbing device and an internal structure of a robot, where FIG. 16(A) illustrates a base-end part of a wrist, FIG. 16(B) illustrates a middle part of the wrist, and FIG. 16(C) illustrates a tip-end part of the wrist. FIGS. 17(A) and 17(B) are schematic cross-sectional views illustrating the conventional shock absorbing device, where FIG. 17(A) is a view before an external force is applied by the human body to an outer shell, and FIG. 17(B) is a view when the external force is applied by the human body.

As illustrated in FIGS. 17(A) and 17(B), an outer shell 210 of the conventional shock absorbing device 200 (hereinafter, referred to as a “conventional outer shell 210”) has a thick wall. The thickness of the thick wall is, for example, 10 mm or above and 15 mm or below. Note that the conventional outer shell 210 is made of urethane foam as a primary component. As illustrated in FIGS. 17(A) and 17(B), when the conventional outer shell 210 is applied with the external force by the human body P etc., a part to which the external force is applied is compressed and its volume is reduced (or its density is increased). Accordingly, the conventional outer shell 210 functions to reduce the shock transmitted to the internal structure of the robot (here, an internal structure 26′ of the wrist).

However, this mode of reducing the shock has room for improvement in a degree of reducing the shock transmitted from the internal structure 26′ of the robot to the human body P. Moreover, an elasticity of the outer shell 210 pushing back the human body changes only linearly with respect to the change in the volume of the outer shell 210. In other words, the elasticity of the outer shell 210 pushing back the human body P does not change largely, when the change in the volume of the outer shell 210 is comparatively small (that is, the external force applied by the human body P to the outer shell 210 is comparatively small). Therefore, a sensor may not detect the external force even when the external force is applied by the human body P to the outer shell 210, and thus, a motion suppressing device which suppresses the motion of the robot based on the value detected by the sensor, may not operate as desired. As a result, the conventional shock absorbing device 200 may not control the operation of the robot as desired.

Moreover, since the conventional outer shell 210 is thick as described above, as illustrated in FIGS. 17(A) and 17(B), an inner surface thereof contacts or almost contacts with the internal structure of the robot. Therefore, when the external force is applied by the human body P, since the change in the volume of the outer shell 210 is obstructed by the internal structure of the robot, the shock absorbing function may not sufficiently be achieved. Moreover, a structure required to be inserted between the outer shell 210 and the internal structure of the robot (e.g., a harness), is difficult to be disposed. Furthermore, once the structure (e.g., the harness) is disposed, it easily contacts the outer shell 210 and the internal structure of the robot, thus easily being damaged.

On the other hand, the shock absorbing device 50 is provided with the outer shell 60 comprised of the elastic body with flexibility, and thus, the shock transmitted from the internal structure (the first object) of the robot 10 to the human body P (the second object) can be sufficiently reduced.

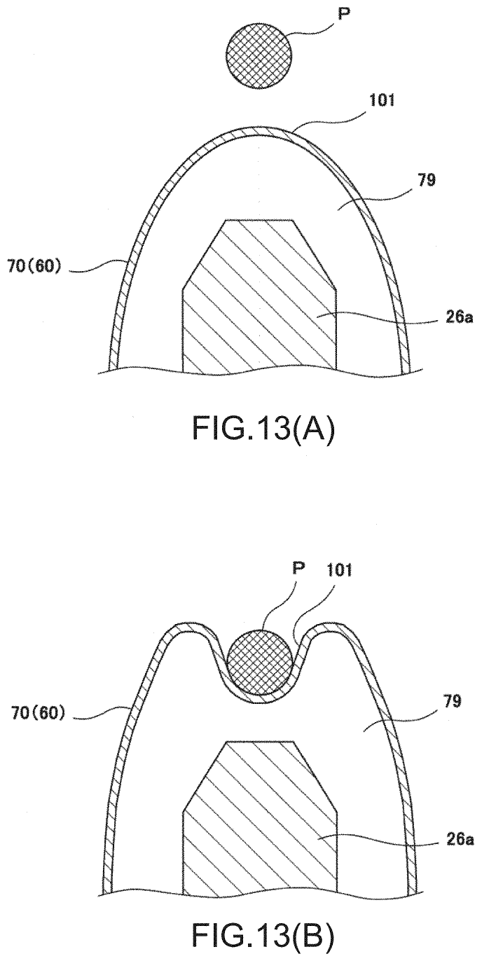

FIGS. 13(A) and 13(B) are schematic cross-sectional views illustrating the effect of the shock absorbing device, where FIG. 13(A) is a view before the external force is applied by the human body to the outer shell, and FIG. 13(B) is a view when the external force is applied by the human body. As illustrated in FIGS. 13(A) and 13(B), a part of the outer shell 60 (here, the first outer shell 70) to which the external force is applied by the human body P is elastically deformed entirely in the thickness direction so as to deflect toward the internal space 79 (a gap). Therefore, the shock transmitted from the internal structure (here, the wrist internal structure 26a, the first object) of the robot 10 to the human body P (the second object) can be sufficiently reduced.

Moreover, the elasticity of the outer shell 60 pushing back the human body P promptly increases compared to the conventional outer shell 210, when the external force applied by the human body P to the outer shell 60 is comparatively small. Therefore, the sensor 110 can more accurately detect the external force applied by the human body P to the outer shell 60 or the external force applied by the human body P to the internal structure of the robot 10 via the outer shell 60. As a result, the motion suppressing device 120 can suppresses the motion of the internal structure of the robot 10 and the outer shell 60 as desired based on the value detected by the sensor.

Moreover, since the outer shell 60 is thin and the gap is formed between the internal structure of the robot 10 and the outer shell 60, the outer shell 60 can elastically deform suitably without being obstructed by other structures, such as the internal structure of the robot 10 and the harness. Furthermore, the structure required to be inserted between the outer shell 60 and the internal structure of the robot 10 (e.g., the harness), can easily be disposed. Moreover, once the structure (e.g., the harness) is disposed as described above, it is unlikely to contact the outer shell 60 and the internal structure of the robot 10, and thus, it can be prevented from being damaged.

Furthermore, by the thickness of the wall being 5.0 mm or below, the outer shell 60 can elastically deform suitably. Moreover, by the thickness of the wall being 1.0 mm or above and 2.0 mm or below, the outer shell 60 can elastically deform more suitably.

Then, since the elastic body constituting the outer shell 60 further has incompressibility, the outer shell 60 can elastically deform suitably, as illustrated in FIGS. 13(A) and 13(B).

Moreover, since the elastic body constituting the outer shell 60 is made of the non-foamed resin, the outer shell can easily be formed. For example, the outer shell 60 can easily be formed by an injection molding at low cost. Furthermore, the outer shell 60 can elastically deform suitably.

At least a part of the outer shell 60 has the curved parts (101, 102, and 103) protruding outwardly in the thickness direction, and thus, the elasticity of the outer shell 60 pushing back the human body P, can be increased further quickly compared to the conventional outer shell 210. Therefore, the sensor 110 can further accurately detect the external force applied by the human body P to the outer shell 60, or the external force applied by the human body P to the internal structure of the robot 10 via the outer shell 60.

Moreover, since the inner surface of the outer shell 60 opposing to the internal structure of the robot 10 is smooth (i.e., ribs etc. are not formed), the outer shell 60 can be formed easily. Moreover, since the rib etc. does not contact other structures, such as the internal structure of the robot 10 and the harness, the outer shell 60 can elastically deform suitably without being obstructed by the other objects.

Moreover, the sensor 110 detects the amount of change in the rotational speed of the motors 30, as the external force applied by the human body P to the internal structures of the robotic arms 20a and 20b via the outer shell 60 (the first part) of the robotic arms 20a and 20b. Therefore, for example, unlikely to the conventional outer shell 210, a contact sensor and a proximity sensor are unnecessary to be built in to detect the external force applied by the human body P. Thus, the outer shell 60 can be thin to suitably be deformed elastically.

(Modifications)

It is apparent for a person skilled in the art that many improvements and other embodiments of the present disclosure are possible from the above description. Therefore, the above description is to be interpreted only as illustration, and it is provided in order to teach a person skilled in the art the best mode for implementing the present disclosure. The details of the structures and/or the functions may be substantially changed, without departing from the spirit of the present disclosure.

Although in the above discussion the first link internal structure 22a and the second outer shell 80 are fixed to each other by the fixing parts 84 including the hook-and-loop fasteners, it is not limited to this. For example, the first link internal structure 22a and the second outer shell 80 may be fixed to each other using a threaded member. Accordingly, the first link internal structure 22a and the second outer shell 80 can easily be fixed to each other without a positional offset. Note that this structure is similarly applied to the attaching of the second link internal structure 24a to the third outer shell 90.

Although the outer shell 60 is configured as the outer shell of the first robotic arm 20a and the second robotic arm 20b, it is not limited to this. For example, if the robot controlling device 18 can control the motion of the pedestal 12, the outer shell 60 may be configured as an outer shell of the base shaft 14, or an outer shell of the pedestal 12.

Although the sensor 110 detects the amount of change in the rotational speed of the motors 30, as the external force applied by the human bodies P and P′ (the second object) to the internal structure of the robot 10 via the outer shell 60, it is not limited to this. For example, the sensor 110 may detect an amount of change in rotational positions of the motors 30 or an amount of change in current values flowing in the motors 30, as the external force applied by the human bodies P and P′ (the second object) to the internal structure of the robot 10 via the outer shell 60.

Although the sensor 110 detects the external force applied by the human bodies P and P′ (the second object) to the internal structure of the robot 10 via the outer shell 60, and the motion suppressing device 120 suppresses the motion of the robot 10 based on the value detected by the sensor 110, it is not limited to this. For example, the sensor 110 may detect the external force applied by the human bodies P and P′ to the outer shell 60, or a physical quantity corresponding to one of the external forces described above (i.e., one of the external force applied by the human bodies P and P′ to the internal structure of the robot 10 via the outer shell 60, and the external force applied by the human bodies P and P′ to the outer shell 60), and the motion suppressing device 120 may suppress the motion of the robot 10 based on the value detected by the sensor 110. Note that the physical quantity corresponding to one of the external forces described above may be an amount of deflection of the outer shell 60, or other physical quantities.

Although the elastic body constituting the outer shell 60 is made of the non-foamed resin and its primary component is polyethylene, it is not limited to this. The elastic body constituting the outer shell 60 may be made of non-foamed resin of which a primary component is polypropylene, polycarbonate, ethylene-vinyl acetate, olefin-based elastomer, styrene-based elastomer, polyamide (nylon), polystyrene, polyacetal, polyurethane, polyethylene terephthalate, vinyl chloride, or polylactic acid. Moreover, the elastic body constituting the outer shell 60 may be made of foamed resin.

Although each of the first robotic arm 20a and the second robotic arm 20b of the robot 10 has the four joint axes JT1-JT4, it is not limited to this. For example, each of the robotic arm 20a and the second robotic arm 20b may have one or more and three or less joint axes, or may have five or more joint axes. Then, the shock absorbing device 50 may be provided with the outer shell 60 which can suitably contain such a robotic arm, and other structures.

Although the robot 10 is configured as the horizontally articulated dual-arm robot having the first robotic arm 20a and the second robotic arm 20b, it is not limited to this. For example, the robot 10 may be configured as a horizontally articulated single-arm robot. Alternatively, the robot 10 may be a polar robot, a cylindrical robot, a cartesian coordinate robot, a vertically articulated robot, or other types of robot. Then, the shock absorbing device 50 may be provided with the outer shell 60 which can suitably contain such a robot, and other structures.

Although the robot 10 is the industrial robot which works cooperatively with the human bodies P and P′ (the second object) at the worksite S, it is not limited to this. For example, the robot 10 may be a so called “entertainment robot,” or may be other types of robot.

Although the second object is the human body P (P′) which works cooperatively with the robot 10 at the worksite S, it is not limited to this. For example, the second object may be a peripheral device which works cooperatively with the robot 10 at the worksite S, or may be other objects disposed at the worksite S. Moreover, when the robot 10 is disposed at a location different from the worksite S, the second object may be a human body or other objects existing at the location.

Although the shock absorbing device 50 is provided to the robot 10, the first object is the internal structure of the robot 10, and the outer shell 60 is the outer shell of the robot, it is not limited to this. For example, the shock absorbing device 50 (and the outer shell 60) may be provided to a robot (the first object) having a structure different from the robot 10, to an electrical equipment (the first object) other than the robot, or to other first objects.

(Experimental Example)

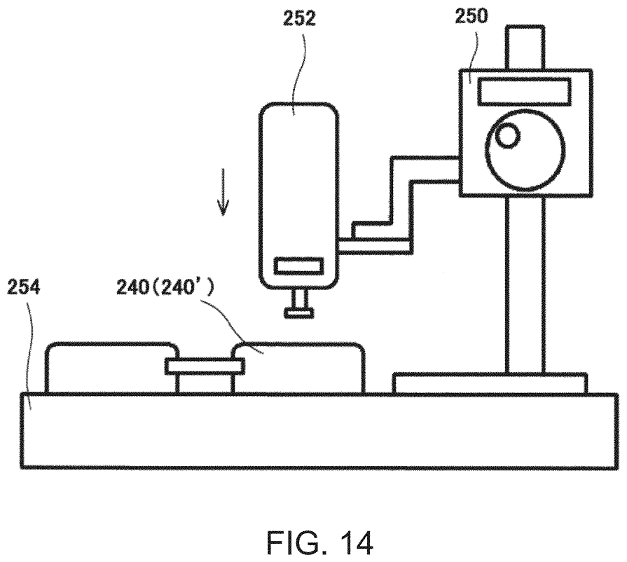

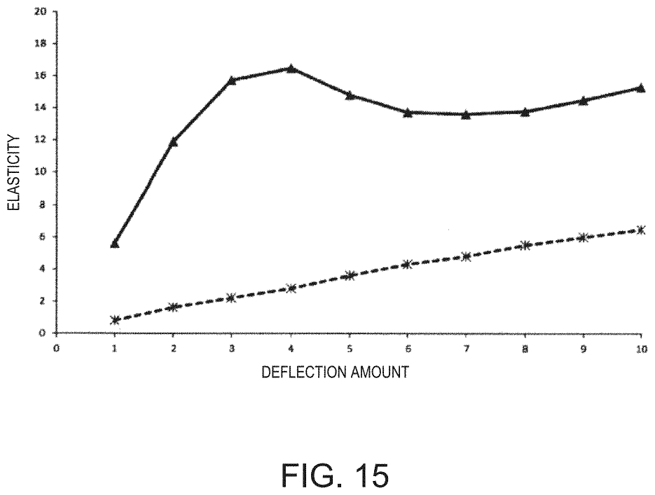

Hereinafter, an experimental example conducted by the present inventors in order to confirm the effect of the present disclosure, is described. FIG. 14 is a schematic view illustrating the experiment conducted by the present inventors in order to confirm the effect of the shock absorbing device. FIG. 15 is a graph illustrating a result of the experiment.

As illustrated in FIG. 14, a sample 240 modeling the first outer shell 70 was manufactured as an example. In this example, the sample 240 was molded by injecting non-foamed resin containing LDPD (Low Density Polyethylene) as a primary component. Moreover, as illustrated in FIG. 14, a sample 240′ of the conventional first outer shell having a similar shape to the sample 240, was manufactured as a comparative example. The sample 240′ of the comparative example was comprised of urethane foam of two-part liquid mixing type.

As illustrated in FIG. 14, each of the sample 240 of the example and the sample 240′ of the comparative example was placed on a surface plate 254, and a center part thereof, which corresponds to the curved part 101 and is located at the highest, was pushed by a push-and-pull gauge 252 while its height being adjusted by a height gauge 250. Accordingly, an elastic force accompanying a change in an amount of deflection (i.e., a force pushing back the push-and-pull gauge 252) was measured regarding each of the example and the comparative example.

The result of the experiment is illustrated in FIG. 15. Measurement values of the example are indicated by a solid line with markers of “Δ” for every deflection amount of 2 mm, and similarly, measurement values of the comparative example are indicated by a broken line with markers of “*”.

As illustrated in FIG. 15, in the comparative example, the measurement values show a linear shape, and the elastic force pushing back the push-and-pull gauge 252 hardly changes when the amount of deflection is comparatively small (i.e., when the external force applied to the sample 240′ of the comparative example is comparatively small).

On the other hand, in the example, the measurement values show a non-linear shape, and the elastic force pushing back the push-and-pull gauge 252 suddenly changes when the amount of deflection is comparatively small (i.e., when the external force applied to the sample 240 of the example is comparatively small, in detail, around a range at 0 mm or above and at 4 mm or below). That is, in this example, the elastic force pushing back the push-and-pull gauge 252 increases more quickly than that in the comparative example. As a result, the effects of the shock absorbing device according to the present disclosure are confirmed.

In accordance with the present disclosure, a shock absorbing device and a robot having the shock absorbing device may be capable of sufficiently reducing shock transmitted from a first object to a second object, and suppressing motion of the first object and an outer shell as desired based on a value detected by a sensor. The shock absorbing device may be configured to reduce shock transmitted from a first object to a second object, and includes an outer shell containing the first object and comprised of an elastic body having flexibility, a sensor configured to detect one of an external force applied by the second object to the outer shell, an external force applied by the second object to the first object via the outer shell, and a physical quantity corresponding to one of the external forces, and a motion suppressing device configured to suppress motion of the first object and the outer shell based on a value detected by the sensor.

According to this configuration, when the external force is applied to the outer shell by the second object, the outer shell is elastically deformed so as to deflect, and thus, the shock transmitted from the first object to the second object can be sufficiently reduced. When the external force applied by the second object to the outer shell is comparatively small, the elasticity of the outer shell pushing back the second object promptly increases compared to an outer shell of a conventional shock absorbing device. Therefore, the sensor can more accurately detect the external force applied by the second object to the outer shell or the external force applied by the second object to the first object via the outer shell. As a result, the motion suppressing device can suppress the motion of the first object and the outer shell as desired based on the value detected by the sensor.

The outer shell may have a wall, and a gap may be formed between the first object and the outer shell. According to this configuration, the outer shell can elastically deform suitably without being obstructed by other structures. For example, the outer shell may reduce the shock transmitted from the first object to the second object by a part of the outer shell to which the external force is applied by the second object being elastically deformed entirely in the thickness direction so as to deflect toward the gap.

The thickness of the wall may be 5.0 mm or below. According to this configuration, the outer shell can elastically deform suitably. The thickness of the wall may be 1.0 mm or above and 2.0 mm or below. According to this configuration, the outer shell can elastically deform more suitably.

The elastic body constituting the outer shell may further have incompressibility. According to this configuration, the outer shell can elastically deform suitably. The elastic body constituting the outer shell may be made of non-foamed resin. According to this configuration, the outer shell can easily be formed and elastically deform suitably. For example, a primary component of the non-foamed resin may be polyethylene. At least a part of the outer shell may have a curved part protruding outwardly in the thickness direction. According to this configuration, the elasticity of the outer shell pushing back the second object, can be increased further quickly compared to the outer shell of the conventional shock absorbing device. Therefore, the sensor can further accurately detect the external force applied by the second object to the outer shell, or the external force applied by the second object to the first object via the outer shell.

An inner surface of the outer shell opposing to the first object may be smooth. According to this configuration, the outer shell can easily be formed and can elastically deform suitably without being obstructed by the other objects. In order to solve the problem, a robot according to the present disclosure is provided, which includes any one of the shock absorbing devices described above, and the first object. The first object is an internal structure of the robot, and the outer shell is an outer shell of the robot. According to this configuration, when the external force is applied to the outer shell by the second object, the outer shell is elastically deformed so as to deflect, and thus, the shock transmitted from the internal structure of the robot (first object) to the second object can be sufficiently reduced. When the external force applied by the second object to the outer shell is comparatively small, the elasticity of the outer shell pushing back the second object promptly increases compared to an outer shell of a conventional shock absorbing device. Therefore, the sensor can more accurately detect the external force applied by the second object to the outer shell or the external force applied by the second object to the internal structure of the robot via the outer shell. As a result, the motion suppressing device can suppress the motion of the robot as desired based on the value detected by the sensor.

For example, the robot may further include a robotic arm having at least one joint axis, and a motor configured to drive the joint axis. The outer shell may include a first part configured to be an outer shell of the robotic arm. The sensor may detect, as an external force applied by the second object to the first object via the first part, one of an amount of change in a rotational position of the motor, an amount of change in a rotational speed of the motor, and an amount of change in a current value flowing in the motor. For example, the second object may be a human body, and the robot may be adapted to be an industrial robot configured to work cooperatively with the human body.

A shock absorbing device and a robot having the shock absorbing device can be provided, which are capable of sufficiently reducing shock transmitted from a first object to a second object, and suppressing motion of the first object and an outer shell as desired based on a value detected by a sensor.

### DESCRIPTION OF REFERENCE CHARACTERS

10 Robot
12 Pedestal
14 Base Shaft
18 Robot Controlling Device
20a, 20b Robotic Arm
22 First Link
22a First Link Internal Structure
23 Decorative Panel
24 Second Link
24a Second Link Internal Structure
26 Wrist
26a Wrist Internal Structure
27 Mechanical Interface
30 Motor
50 Shock Absorbing Device
60 Outer Shell
70 First Outer Shell
72 First Outer Shell Body
73 Snap-Fit Structure
73a Male Part
73b Female Part
76 First Outer Shell Back Part
77 Vent
78 Heat Sink
79 Internal Space
80 Second Outer Shell
82 Second Outer Shell Body
84, 96 Fixing Part
85 Sponge Foam
86, 87, 98, 99 Hook-And-Loop Fastener
90 Third Outer Shell
92 Third Outer Shell Body
93 Third Outer Shell Side Part
94 Third Outer Shell One Surface Part
95 Third Outer Shell Other Surface Part
97 Sponge Foam
101, 102, 103 Curved Part
110 Sensor
120 Motion Suppressing Device
200 Conventional Shock Absorbing Device
210 Conventional Outer Shell
240 Sample
250 Height Gauge
252 Push-And-Pull Gauge
254 Surface Plate
J1-J4 Joint Part
L1, L2 Rotational Axis
C Conveyor
P Human Body
S Worksite
W Workpiece

What is claimed is:

1. A shock absorbing device configured to reduce shock transmitted from a first object to a second object, the shock absorbing device comprising:
an outer shell comprising of an elastic body, the outer shell configured to contain the first object;
a sensor configured to detect one of a first external force applied by the second object to the outer shell, a second external force applied by the second object to the first object via the outer shell, and a physical quantity corresponding to one of the first and second external forces; and
a motion suppressing device configured to suppress motion of the first object and the outer shell based on a value detected by the sensor.

2. The shock absorbing device of claim 1, wherein
the outer shell includes a wall, and
a gap is formed between the first object and the outer shell.

3. The shock absorbing device of claim 2, wherein the outer shell reduces the shock transmitted from the first object to the second object by a part of the outer shell to which the external force is applied by the second object being elastically deformed entirely in the thickness direction so as to deflect toward the gap.

4. The shock absorbing device of claim 2, wherein the thickness of the wall is 5.0 mm or below.

5. The shock absorbing device of claim 4, wherein the thickness of the wall is 1.0 mm or above and 2.0 mm or below.

6. The shock absorbing device of claim 1, wherein the elastic body has an incompressible property.

7. The shock absorbing device of claim 1, wherein the elastic body is a non-foamed resin.

8. The shock absorbing device of claim 7, wherein a primary component of the non-foamed resin is polyethylene.

9. The shock absorbing device of claim 1, wherein at least a part of the outer shell is curved protruding outwardly in a thickness direction.

10. The shock absorbing device of claim 1, wherein an inner surface of the outer shell opposing to the first object is a smooth surface.

11. The shock absorbing device of claim 1, wherein
the outer shell comprises a first outer shell and a second outer shell, and
the first outer shell and the second outer shell snap together around the first object.

12. A robot, comprising:
the shock absorbing device of claim 1; and
the first object, wherein
the first object is an internal structure of the robot, and
the outer shell is an outer shell of the robot.

13. The robot of claim 12, further comprising:
a robotic arm having at least one joint axis; and
a motor configured to drive the joint axis, wherein
the outer shell includes a first part configured to be an outer shell of the robotic arm, and
the sensor detects, as an external force applied by the second object to the first object via the first part, one of an amount of change in a rotational position of the motor, an amount of change in a rotational speed of the motor, and an amount of change in a current value flowing in the motor.

14. The robot of claim 12, wherein
the second object is a human body, and
the robot is adapted to be an industrial robot configured to work cooperatively with the human body.

15. A shock absorbing device, comprising:
an outer shell comprising an elastic body, the outer shell housing a first object;
a sensor configured to detect one of a first external force applied by a second object to the outer shell, a second external force applied by the second object to the first object via the outer shell, and a physical quantity corresponding to one of the first and second external forces; and
a motion suppressing device configured to suppress motion of the first object and the outer shell based on a value detected by the sensor, wherein
the shock absorbing device reduces shock transmitted from the first object to the second object.

16. The shock absorbing device of claim 15, wherein
the outer shell includes a wall, and
a gap is formed between the first object and the outer shell.

17. The shock absorbing device of claim 16, wherein the outer shell reduces the shock transmitted from the first object to the second object by a part of the outer shell to which the external force is applied by the second object being elastically deformed entirely in the thickness direction so as to deflect toward the gap.

18. The shock absorbing device of claim 16, wherein the thickness of the wall is 5.0 mm or below.

19. The shock absorbing device of claim 15, wherein
the outer shell comprises a first outer shell and a second outer shell, and
the first outer shell and the second outer shell snap together around the first object.

20. A robotic device, comprising:
a first object;
an outer shell comprising an elastic body, the outer shell housing the first object;
a sensor configured to detect one of a first external force applied by a second object to the outer shell, a second external force applied by the second object to the first object via the outer shell, and a physical quantity corresponding to one of the first and second external forces; and
a motion suppressing device configured to suppress motion of the first object and the outer shell based on a value detected by the sensor, wherein
the outer shell reduces shock transmitted from the first object to the second object, wherein
the first object is an internal structure of the robot.
